(19) United States
(12) Patent Application Publication
(10) Pub. No.: US 2009/0064051 A1
(43) Pub. Date: Mar. 5, 2009

(54) INTERACTIVE SYSTEM FOR VISUALIZATION AND RETRIEVAL OF VIDEO DATA

(75) Inventor: Borivoje Furht, Boca Raton, FL (US)

Correspondence Address: AKERMAN SENTERFITT, P.O. BOX 3188, WEST PALM BEACH, FL, 33402-3188, US

(73) Assignee: Florida Atlantic University, Boca Raton, FL (US)

(21) Appl. No.: 12/200,565

(22) Filed: Aug. 28, 2008

Related U.S. Application Data
(60) Provisional application No. 60/969,517, filed on Aug. 31, 2007.

(51) Int. Cl. G06F 3/048; G06T 15/00

(52) U.S. Cl. 715/848; 345/419

(57) ABSTRACT

A cube-based three-dimensional interactive system is provided for visualization and retrieval of video data. The system includes at least one interactive cube having eight nodes, each node being linked to a specific data item. The data items on the nodes are organized in space or time. Textual information about a respective data item appears upon traversing the corresponding node and the data items opens up upon selection. The interactive cube can be expanded to include more than eight nodes, such as 12 or 18 nodes. The system can also have multiple cubes that are connected to form a one-level, multi-level or multi-dimensional hypercube

### CROSS-REFERENCE TO RELATED APPLICATIONS

This application claims the priority of U.S. Provisional Application 60/969,517, which was filed on Aug. 31, 2007 with the U.S. Patent and Trademark Office and which is incorporated herein in its entirety.

### FIELD OF THE INVENTION

The present invention is related to fields of video display and retrieval, and more particularly, to systems and methods for retrieving video data as well as generating visual displays of same based on hypercube structures.

### BACKGROUND OF THE INVENTION

Recent advances in Internet and video technology, including mobile and wireless systems, allow high-quality resolution video to be displayed on a desktop as well as various mobile systems. High speed networks provide high bandwidth, which likely will soon allow users to receive multiple real-time videos on such devices. It is assumed by many that technology is on the verge of a Web-based video revolution, in which viewers will be able to receive and process video applications in an entirely different manner than in the past. Besides simply watching videos, a user may also be able to create content, thus allowing the user to create unique videos, upload videos and own individual channels.

A number of efforts are underway to offer a variety of video-based applications, predominately in the area of entertainment. Basically, the underlying techniques and mechanisms provide a similar functionality and similar user experience. Various video clips can be stored on one or more servers and a set of videos presented sequentially (or linearly) on a selected Webpage. The user can click on a selected video icon, a larger window will open, and the user can then watch the video. There is a VCR-type of functionality for controlling the video (Start, Stop, Forward, etc.). Examples of screen presentations from several proprietary sources are shown in FIGS. 1 and 2.

Navigation through the system can be effected by clicking various categories, or by using search function to search and retrieve videos using key words. However, this sequential (or linear) structure typically does not provide an exciting user experience, especially for younger users, who typically have typically been widely exposed to video games from a very early age. Notably, there typically are nonspecific links between various video, that connect topics in space and time.

US Patent Application No. 2003/0001904 A1 (Rosen et al.) describes a tool for generating a standardized multimedia presentation as well as a viewer for presenting such a presentation. The presentation is presented to the user through a graphical user interface in the form of a three-dimensional geometric object, such as, a 3-by-3 cube. The end user can choose any topic from the cubes and then choose any subtopic.

U.S. Pat. No. 7,146,576, (Chang et al.) describes an apparatus and method for browsing a plurality of data objects represented by images displayed within a three-dimensional graphical environment. The representative images of the data objects are arranged within the three-dimensional graphical environment in a manner based on which one of the schemes is selected

US 2002/0163546 A1 (Gallo) describes a method of representing information on a three-dimensional user interface having multiple portals, in which data is associated with each of the portals. A symbolic marker is associated with each of the portals according to a pre-specified scheme, and displayed in the respective portals.

However, none of the above-mentioned documents discloses a cube-based interactive system to connect video data in space and time as well as to combine video data from different sources.

### SUMMARY OF THE INVENTION

In view of this background, it is an object of the present invention to provide an interactive system for the visualization and retrieval of video data based on hypercube structures. The interactive system for visualization and retrieval of video data allows content creators to connect video data in space and time as well as combine video data from different sources. The interactive system provides an enhanced experience both for content creators and for users. Content creators can organize and visualize a complex video data structure in a well-structured way, and can combine video data in space and time. The users can easily navigate through a number of video clips in space and time.

According to one aspect, the present invention provides a cube-based, three-dimensional interactive system for visualization and retrieval of data. The system includes at least one interactive cube having eight nodes, each node being linked to a data item, the data items on the nodes being organized in space or time. Textual information pertaining to a respective data item appears upon traversing the corresponding node and the data item opens up upon selection.

Although the system is particularly suitable for video clips, the data items may also include numeric, textual, audio, or multimedia files.

The interactive cube is expandable so as to include more than eight nodes, such as 12, 18, or even more nodes. The system may also includes a plurality of interactive cubes connected with one another to form a one-level, multi-level, or multi-dimensional hypercube.

### BRIEF DESCRIPTION OF THE DRAWINGS

The present invention is illustrated by way of example and not limitation in the accompanying drawings in which like reference numbers indicate similar parts, and in which:

FIG. 1 provides two screen shots from www.youtube.com.

FIG. 2 provides screen shots from www.current.tv and www.lulu.tv.

FIG. 3 illustrates a cube-based interface with information about the video and enlarged playing video clip.

FIG. 4A illustrates a dual-cube with 12 nodes.

FIG. 4B illustrates a quadratic cube with 18 nodes.

FIG. 5 illustrates an example of a hypercube extension consisting of space and time cubes.

FIG. 6 illustrates a multi-level hypercube.

FIG. 7 illustrates-a two-dimensional hypercube.

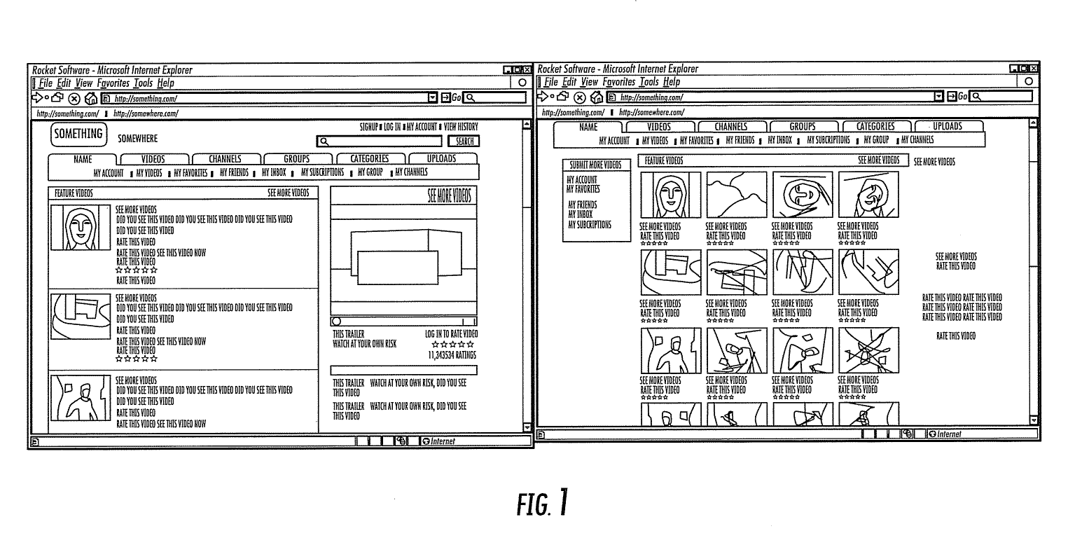

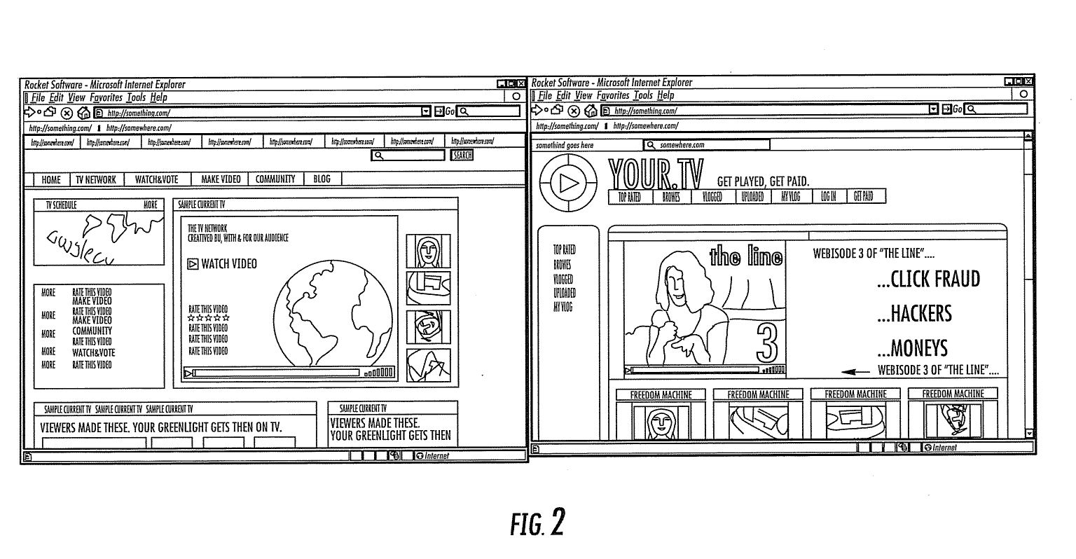

### DETAILED DESCRIPTION OF THE INVENTION

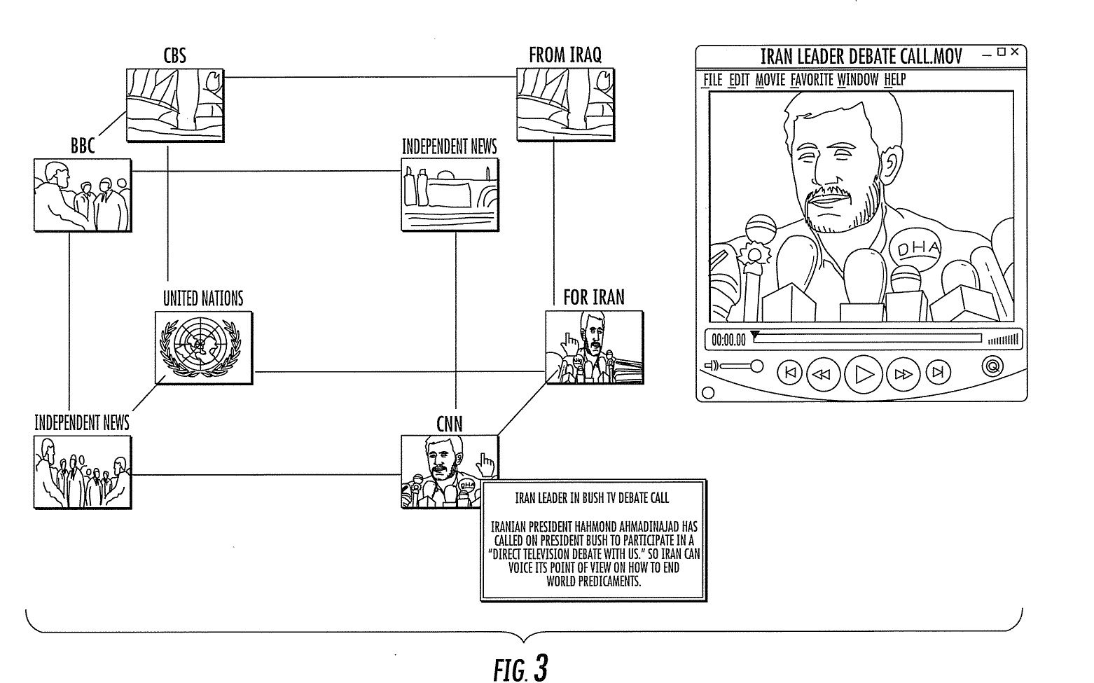

A method of creating an interactive user interface according to one embodiment is an interactive cube with eight nodes, as illustrated by example in FIG. 3. Each node is linked to a specific video (or eventually to another level of a cube interface). In this specific example, the interactive cube presents a set of current news video clips on a current new event (e.g., war), combined from different parts of the world. Each node contains a small video icon. The content creator can combine video clips from different sources and create a three-dimensional view of videos. The user can navigate through the cube space and the cube will rotate accordingly. As the user traverses a node (video icon) with a controller (e.g., a computer mouse), textual information about the related video will appear on the screen, as indicated in FIG. 3. The user can select and play the video by clicking on a node. The selected video will begin playing on the screen, as illustrated in FIG. 3.

Similarly, a time cube can be created, whereby video clips on the same or related topics are linked in time. The user can travel through the cube in time and select and watch the video.

The basic cube as shown in FIG. 3 and described above can be expanded or extended to provide more in formation (additional videos and additional multi-dimensional links). This allows an effective visualization of a large number of video data, including large video archives. The user gets more exciting experience in traveling through the space or time and searching for videos.

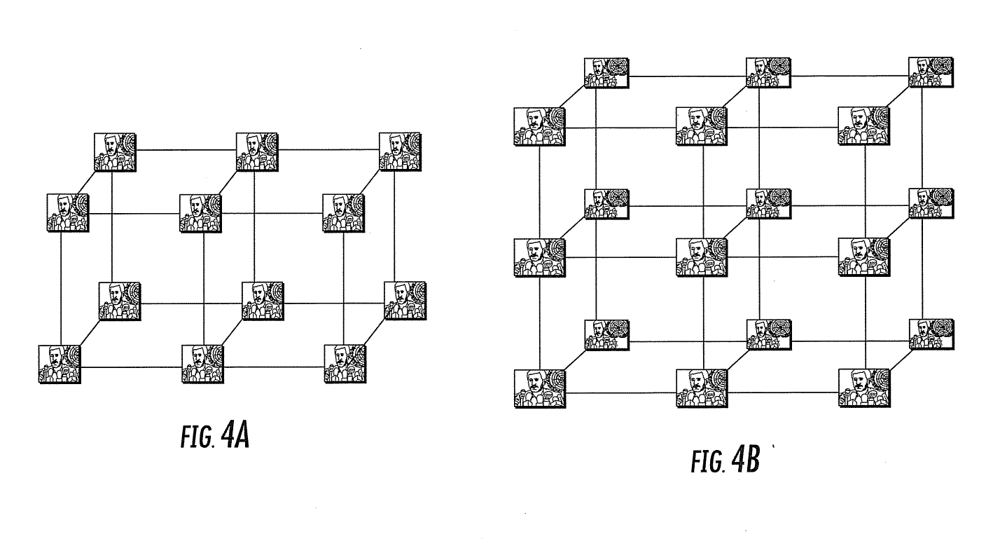

FIG. 4A shows a dual cube with 12 nodes and FIG. 4B shows a quadratic, cube with 18 nodes. These structures allow more than 8 videos to be linked together in space and time.

Another possible extension is connecting two or several cubes and building hypercubes. An example in FIG. 5 illustrates connecting two cubes. A possible scenario is that from the video clip, which connects these two cubes, one cube to the left is a space-connected cube and another on the right is a time-connected cube. This method allows content creators to efficiently create, combine and link video clips in space and time. The user can then travel through the space and time and look for and select related video clips.

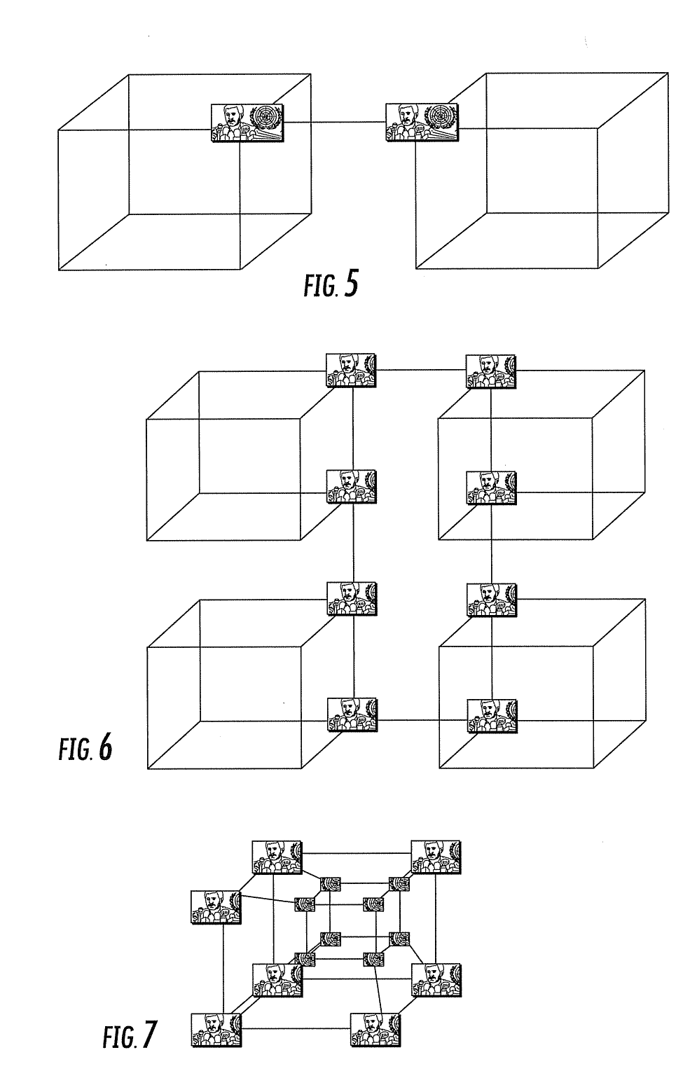

This model can be further extended to a multi-level hypercube, as illustrated in FIG. 6. Finally, multi-dimensional hypercubes can be created, as illustrated in FIG. 7. The two-dimensional hypercube in FIG. 7 provides an interesting link of an inner and outer cube, where related nodes (video clips) are interconnected.

The basic principles of navigation through the proposed hypercube structures have already been described above. The user travels through the hypercubes in space and time, gets basic descriptions of the videos in the hypercube, and selects the video for viewing. The hypercube model allows the user to get a comprehensive view of available videos on specific topics, and their space and time relationship.

In the emerging field of Internet applications relating to entertainment and news, there is a great number of applications which can take advantage of the proposed hypercube based user interface of the present invention. Practically, all the companies, which offer video applications (entertainment, news, etc) currently use tremendous number of videos. The proposed hypercube structure will help them to better organize and link these videos by their theme, and in space and time, and present to the user. The user will have a completely new experience in traveling through time and space hypercubes, and in selecting and watching videos.

The hypercube-based system according to the present invention can also be used for visualization and retrieval of other types of computer data including data, numeric, textual, audio, or multimedia files. In these cases, the nodes in the cube will present a general file rather then a video clip.

Finally, with emerging 3D displays, which are becoming affordable for mass usage, the hypercube-based interactive system of the invention presents a right tool for human-machine interaction.

The invention can be realized in hardware (e.g., one or more processors communicatively linked to computer memory) or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A cube-based three-dimensional interactive system comprising a combination of computer hardware and software for the visualization and retrieval of data, the system comprising:
at least one three-dimensional interactive cube haying eight nodes, each node being linked to a data item, the data items on the nodes being organized according to space or time;
wherein textual information corresponding to a respective data item appears in response to traversing the corresponding node and the data item opens up upon selection.

2. The cube-based three-dimensional interactive system according to claim 1, wherein the data items include numeric, textual, audio, video or multimedia files.

3. The cube-based three-dimensional interactive system according to claim 1, wherein the three-dimensional interactive cube is expandable to include more than eight nodes.

4. The cube-based three-dimensional interactive system according to claim 1, wherein the system includes a plurality of three-dimensional interactive cubes connected to form a hypercube.

5. The cube-based three-dimensional interactive system according to claim 1, wherein the hypercube is a multi-level hypercube or a multi-dimensional hypercube.

6. The cube-based three-dimensional interactive system according to claim 1, wherein the three-dimensional interactive cube rotates responsive to a user navigating through the nodes.

7. A computer-implemented method of visualization and retrieval of data using computer hardware comprising at least one processor and visual interface, the method comprising:
generating a three-dimensional interactive cube having eight nodes, each node being linked to a data item, the data items on the nodes being organized in space or time;
presenting textual information corresponding to a respective data item in response to a user traversing the corresponding node, wherein the data item opens up upon selection by the user.

8. The method according to claim 7, wherein the data items include numeric, textual, audio, video or multimedia files.

9. The method according to claim 7, wherein the interactive cube is expandable to include more than eight nodes.

10. The method according to claim 7, wherein a plurality of three-dimensional interactive cubes are connected with one another to form a hypercube.

11. The method according to claim 10, wherein the hypercube is a multi-level hypercube or a multi-dimensional hypercube.

12. The method according to claim 7, further comprising rotating the three-dimensional interactive cube responsive to the user navigating through the nodes.

13. A machine-readable storage having stored thereon, a computer program having a plurality of code sections, said code sections executable by a machine for causing the machine to perform the steps of:
generating a three-dimensional interactive cube having eight nodes, each node being linked to a data item, the data items on the nodes being organized in space or time;
presenting textual information corresponding to a respective data item in response to a user traversing the corresponding node, wherein the data item opens up upon selection by the user.

14. The machine-readable storage according to claim 13, wherein the data items include numeric, textual, audio, video or multimedia files.

15. The machine-readable storage according to claim 13, wherein the interactive cube is expandable to include more than eight nodes.

16. The machine-readable storage according to claim 13, wherein a plurality of three-dimensional interactive cubes are connected with one another to form a hypercube.

17. The machine-readable storage according to claim 16, wherein the hypercube is a multi-level hypercube or a multi-dimensional hypercube.

18. The machine-readable storage according to claim 13, further comprising rotating the three-dimensional interactive cube responsive to the user navigating through the nodes.
